(19) United States
(12) Patent Application Publication
(10) Pub. No.: US 2011/0135191 A1
(43) Pub. Date: Jun. 9, 2011

(54) APPARATUS AND METHOD FOR RECOGNIZING IMAGE BASED ON POSITION INFORMATION

(75) Inventors: Chun Gi LYUH, Daejeon (KR); Ik Jae CHUN, Daejeon (KR); Jung Hee SUK, Daejeon (KR); Tae Moon ROH, Daejeon (KR)

(73) Assignee: Electronics and Telecommunications Research Institute, Daejeon (KR)

(21) Appl. No.: 12/779,237

(22) Filed: May 13, 2010

(30) Foreign Application Priority Data
Dec. 9, 2009 (KR) 10-2009-0121888

(51) Int. Cl. G06K 9/64

(52) U.S. Cl. 382/159

(57) ABSTRACT

According to the present invention, the amount of computation required for image recognition processing can be reduced by extracting only image recognition learning information for an object that may appear in a region having the geographical property of a current position and comparing the image recognition learning information with ambient-image information.

### CROSS-REFERENCE TO RELATED APPLICATION

This application claims priority to and the benefit of Korean Patent Application No. 10-2009-0121888, filed Dec. 9, 2009, the disclosure of which is incorporated herein by reference in its entirety.

### BACKGROUND

1. Field of the Invention

The present invention relates to an image recognition apparatus and method, and more particularly, to an image recognition apparatus and method for identifying an object using ambient-image information in robots or vehicles.

2. Discussion of Related Art

In recent years, image recognition methods have been studied in a variety of fields, including safe driving of vehicles and robots. However, because an object to be recognized is an image having a great amount of data to be processed, a great amount of computation is required and the accuracy of recognition is degraded. Accordingly, it is impractical to apply the method. This problem will be described with reference to FIG. 1.

FIG. 1 is a block diagram of a conventional image recognition system. Referring to FIG. 1, a conventional image recognition system includes an ambient-image information acquisition unit 10, an image recognition learning information database 30, an image recognition processor 50, and a controller 60.

The ambient-image information acquisition unit 10 outputs ambient-image information acquired by photographing an ambient image. The ambient-image information acquisition unit 10 may be a camera.

The image recognition learning information database 30 stores image recognition learning information obtained by iteratively performing a learning process using training image information for a recognition object.

The image recognition processor 50 compares the ambient-image information received from the ambient-image information acquisition unit 10 with all the image recognition learning information received from the image recognition learning information database 30 to determine whether there is image recognition learning information matching the ambient-image information. When there is image recognition learning information matching the ambient-image information, the image recognition processor 50 outputs the result of determination to the controller 60.

The controller 60 generates and outputs various control signals according to the received determination result.

Since the ambient-image information is compared with all image recognition learning information stored in the image recognition learning information database 330, the conventional image recognition system as described above requires a great amount of computation and thus has a low image recognition processing speed.

Meanwhile, decreasing the amount of the image recognition learning information to obtain a high image recognition processing speed degrades accuracy of image recognition processing.

Accordingly, there is a need for an image recognition apparatus and method having a high accuracy and speed of image recognition processing.

### SUMMARY OF THE INVENTION

The present invention is directed to an image recognition apparatus and method that perform accurate image recognition processing at a high image recognition processing speed.

Other objects of the present invention will be recognized from exemplary embodiments of the present invention.

One aspect of the present invention provides an apparatus for recognizing an image based on position information, the apparatus including: a global positioning system (GPS) receiver for receiving current position information; an ambient-image information acquisition unit for acquiring ambient-image data by photographing an ambient image; an image recognition learning information database for storing image recognition learning information for each image recognition object; an image recognition learning information selector for selecting image recognition learning information associated with a geographical property of the current position from the image recognition learning information database based on the received current position information; and an image recognition processor for performing image recognition on the acquired ambient-image data based on the selected image recognition learning information.

The apparatus may further include a geographical property-specific image recognition object list database for storing an image recognition object list designating an image recognition object according to a geographical property. The image recognition learning information selector may extract an image recognition object list including an image recognition object at the current position from the geographical property-specific image recognition object list database based on the received current position information, and the image recognition processor may search for image recognition learning information corresponding to the extracted image recognition object list from the image recognition learning information database, and recognize an image included in the ambient-image data based on the searched image recognition learning information.

The apparatus may further include a geographical property information database for storing geographical property information dependent on positions. The image recognition learning information selector may extract the geographical property information of the current position from the geographical property information database based on the received current position information.

The image recognition learning information database may store at least one item of image recognition learning information for each image recognition object produced using training image information having a different feature according to a geographical property.

The image recognition processor may select image recognition learning information having a feature corresponding to the geographical property of the current position from among the image recognition learning information corresponding to the extracted image recognition object list.

The apparatus may further include a controller for generating a control signal according to the result of performing the image recognition.

The apparatus may further include an output unit for outputting an image or sound according to the control signal.

Another aspect of the present invention provides a method for recognizing an image based on position information, the method including: receiving current position information; acquiring ambient-image data by photographing an ambient image; selecting image recognition learning information associated with a geographical property of the current position based on the received current position information; and performing image recognition on the acquired ambient-image data based on the selected image recognition learning information.

The selecting of the image recognition learning information may include: extracting an image recognition object list including an image recognition object at the current position based on the received current position information; and searching for and selecting image recognition learning information corresponding to the extracted image recognition object list.

The receiving of the current position information may include receiving the current position information from a user or using a GPS.

The method may further include building an image recognition learning information database for storing image recognition learning information for each image recognition object.

The building of the image recognition learning information database may include producing at least one item of image recognition learning information for each image recognition object using training image information having a different feature according to a geographical property.

The searching and selecting of the image recognition learning information may include extracting image recognition learning information having a feature corresponding to the geographical property of the current position from among the image recognition learning information corresponding to the extracted image recognition object list.

The method may further include building a geographical property information database for storing geographical property information dependent on positions.

The method may further include building a geographical property-specific image recognition object list database for storing an image recognition object list designating an image recognition object according to a geographical property.

The method may further include generating a control signal according to the result of performing the image recognition.

The method may further include outputting an image or sound according to the control signal.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a conventional image recognition system;

FIG. 2 is a block diagram of an apparatus for recognizing an image based on position information according to an exemplary embodiment of the present invention;

FIG. 3 illustrates mapping information in the geographical property information database built according to an exemplary embodiment of the present invention;

FIG. 4 illustrates a geographical property-specific image recognition object list stored in the geographical property-specific image recognition object list database built according to an exemplary embodiment of the present invention;

FIG. 5 illustrates an image recognition learning information database built according to an exemplary embodiment of the present invention;

FIG. 6 is a flowchart illustrating a process of recognizing an image based on position information according to an exemplary embodiment of the present invention; and

FIG. 7 is a flowchart illustrating a process of recognizing an image based on position information according to another exemplary embodiment of the present invention.

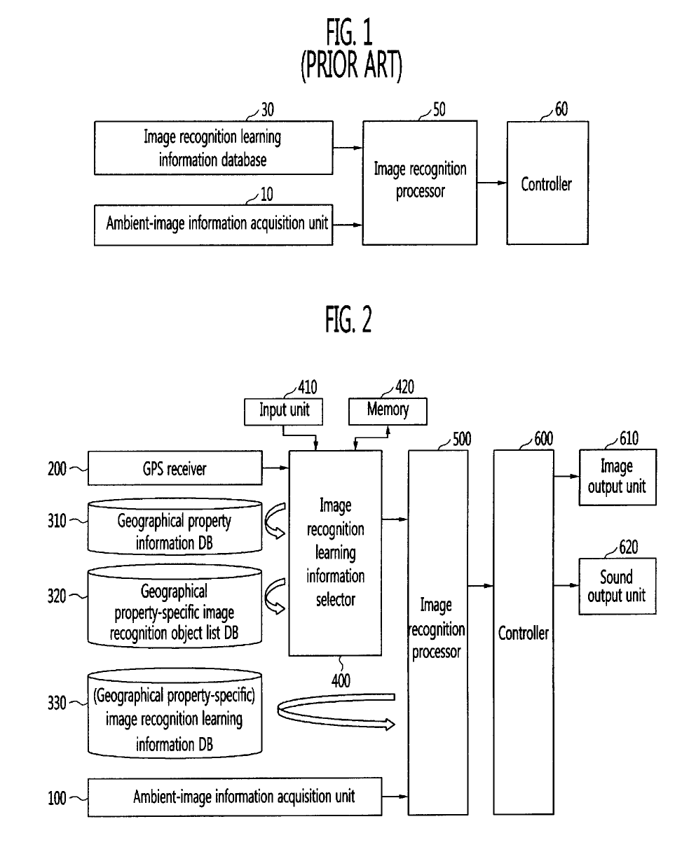

### DETAILED DESCRIPTION OF EXEMPLARY EMBODIMENTS

Hereinafter, exemplary embodiments of the present invention will be described in detail with reference to the accompanying drawings. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

As described above, the conventional image recognition system has a very low image recognition processing speed because ambient-image information acquired using, for example, a camera is compared with all image recognition learning information stored in the image recognition learning information database when image recognition processing is performed.

Accordingly, the present invention provides an apparatus and method capable of greatly improving an image recognition processing speed by recognizing a geographical property of a current position of, for example, a robot or a vehicle, extracting only image recognition learning information for an object that may appear in a region having the recognized geographical property of the current position, and comparing the extracted image recognition learning information with ambient-image information.

The present invention also provides an apparatus and method capable of greatly improving an image recognition processing speed and increasing the accuracy of image recognition processing by building an image recognition learning information database according to a geographical property using training image information having a different feature according to the geographical property for the same type of objects having several different features according to the geographical property, and performing image recognition processing using the built database.

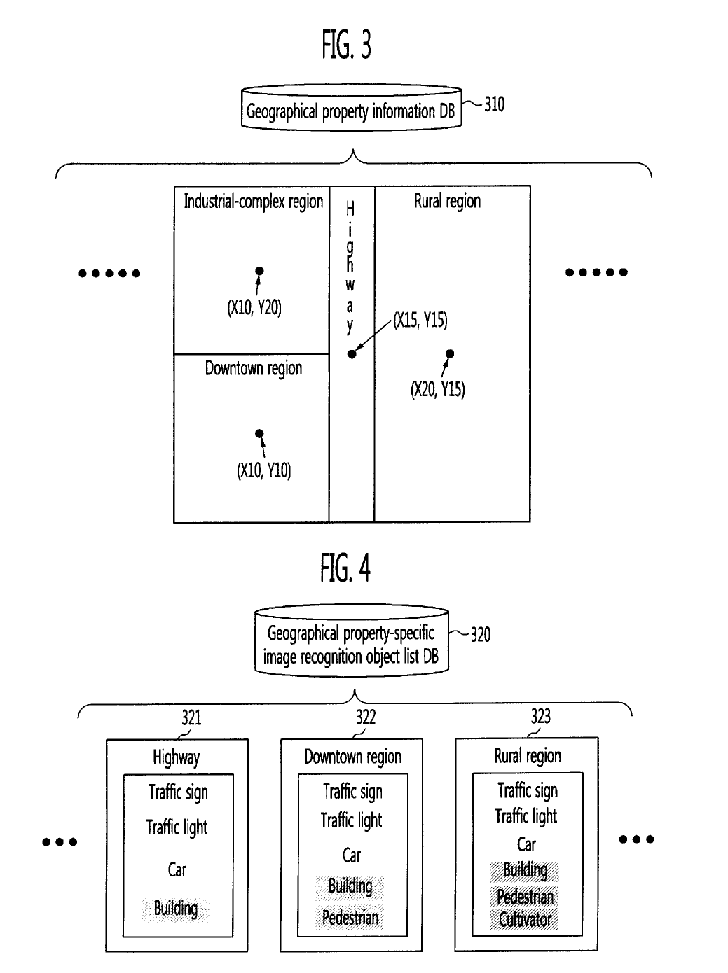

FIG. 2 is a block diagram of an apparatus for recognizing an image based on position information according to an exemplary embodiment of the present invention.

Referring to FIG. 2, an apparatus for recognizing an image based on position information according to an exemplary embodiment of the present invention includes an ambient-image information acquisition unit 100, a global positioning system (hereinafter, referred to as GPS) receiver 200, a geographical property information database (DB) 310, a geographical property-specific image recognition object list database 320, an image recognition learning information database 330, an image recognition learning information selector 400, an input unit 410, a memory 420, an image recognition processor 500, a controller 600, an image output unit 610 and a sound output unit 620.

The ambient-image information acquisition unit 100 photographs the foreground or the background of a robot or a vehicle every set time to acquire ambient-image information, and outputs the acquired ambient-image information to the image recognition processor 500. The ambient-image information acquisition unit 100, which may include a camera, may be disposed inside or outside the robot or the vehicle.

The GPS receiver 200 recognizes a current position of the robot or the vehicle according to a typical GPS positioning scheme. That is, the GPS receiver 200 receives a signal from a satellite to recognize the current position of the robot or the vehicle, and outputs the current position information to the image recognition learning information selector 400.

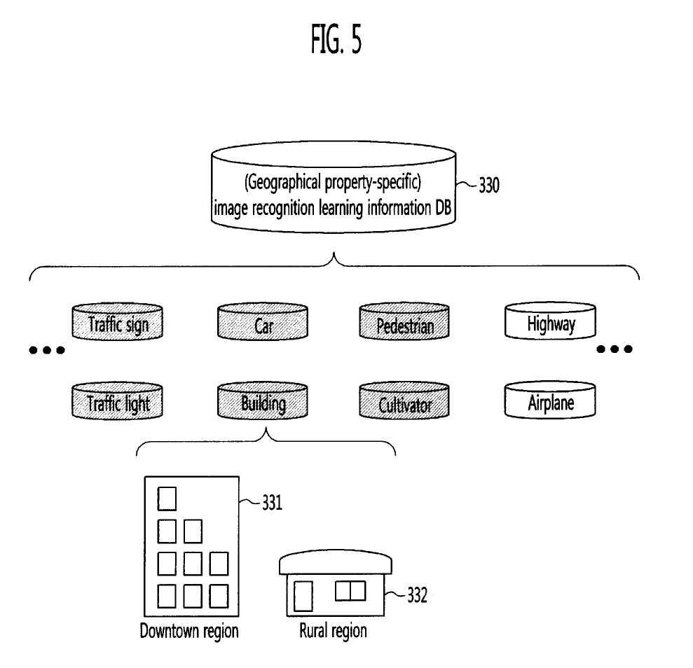

The geographical property information database 310 stores geographical property information dependent on positions. This geographical property information database 310 may be built using various methods. For example, the geographical property information database 310 may be built by mapping a geographical property of each region to coordinate information used, for example, in a GPS system. This will be described with reference to FIG. 3.

FIG. 3 illustrates mapping information in the geographical property information database built according to an exemplary embodiment of the present invention.

Referring to FIG. 3, a region having coordinate information of “X10, Y10” is mapped to a “downtown region,” a region having coordinate information of “X10, Y20” is mapped to an “industrial-complex region,” a region having coordinate information of “X15, Y15” is mapped to a “highway,” and a region having coordinate information of “X20, Y50” is mapped to a “rural region.”

That is, the geographical property information including the geographical properties mapped to various coordinate information is stored in the geographical property information database 310.

The geographical property information database 310 as described above may be built by classifying regions having a different geographical property, mapping coordinate information to each region, and storing geographical property information indicating a region to which the coordinates belong.

Referring back to FIG. 2, the geographical property-specific image recognition object list database 320 stores a geographical property-specific recognition object list that is a recognition object list according to a geographical property of each region.

The geographical property-specific image recognition object list database 320 may be built using various methods. For example, the geographical property-specific image recognition object list database 320 may be built by classifying several geographical properties according to a certain criterion and setting a recognition object in a region having each classified geographical property. This will be described with reference to FIG. 4.

FIG. 4 illustrates a geographical property-specific image recognition object list stored in the geographical property-specific image recognition object list database built according to an exemplary embodiment of the present invention.

For convenience of illustration, the geographical properties are classified into three: highway, downtown region and rural region in FIG. 4. The geographical properties may be classified variously according to the intention of a user or a manager.

An image recognition object list for each geographical property is shown in FIG. 4. An image recognition object list 321 for a highway includes a “traffic sign,” a “traffic light,” a “car” and a “building.” An image recognition object list 322 for a downtown region includes a “traffic sign,” a “traffic light,” “car,” a “building” and a “pedestrian.” An image recognition object list 323 for a rural region includes a “traffic sign,” a “traffic light,” a “car,” a “building,” a “pedestrian” and a “cultivator.”

Since the “pedestrian” and the “cultivator” are less likely to be in the highway, the “pedestrian” and the “cultivator” are not set as the image recognition objects.

Meanwhile, since the “pedestrian” is highly likely to be in the downtown region and the “pedestrian” and the “cultivator” are highly likely to be in the rural region, the “pedestrian” and the “cultivator” are set as the image recognition objects.

Referring back to FIG. 2, the image recognition learning information database 330 stores image recognition learning information for recognition objects.

The image recognition learning information database 330 may be built by performing learning for each image recognition object using various training image information. The image recognition learning information database 330 may be built using several methods used to produce conventional image recognition learning information.

For example, image recognition learning information for a building can be produced through iterative learning using training image information including the building and training image information not including the building. As the image recognition learning information for each image recognition object is produced, the image recognition learning information database 330 is built.

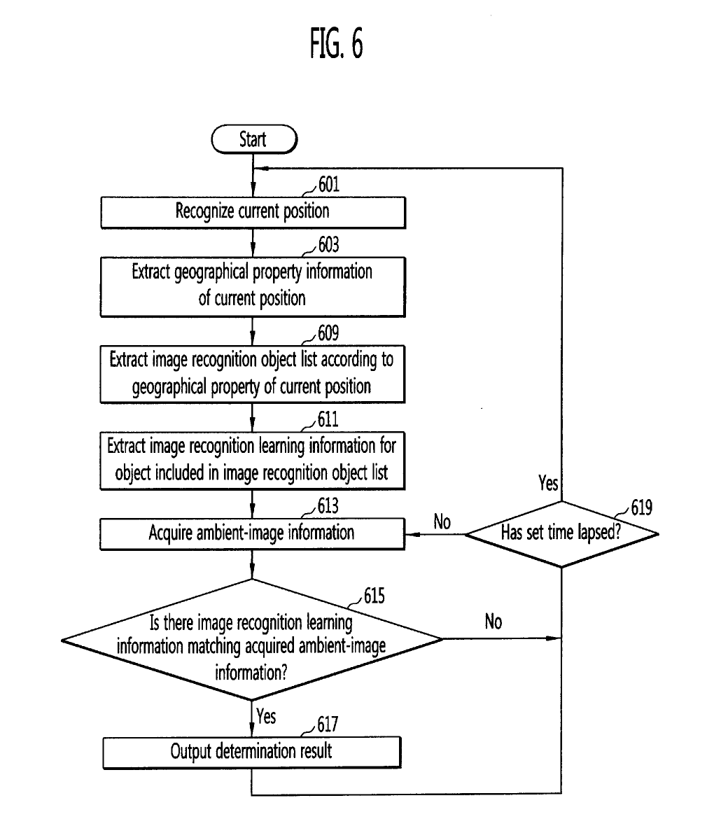

Meanwhile, when the image recognition learning information database 330 is built, the image recognition learning information having a different feature according to a geographical property can be produced through learning for the recognition object using training image information having the different feature according to the geographical property. This will be described with reference to FIG. 5.

FIG. 5 illustrates an image recognition learning information database built according to an exemplary embodiment of the present invention.

Referring to FIG. 5, an image recognition learning information database 330 stores image recognition learning information for image recognition objects, such as a “traffic sign,” a “car,” a “pedestrian,” an “overpass,” a “traffic light,” a “building,” a “cultivator” and an “airplane.”

Meanwhile, the image recognition learning information database 330 may store various image recognition learning information produced using training image information having a different feature according to a geographical property. The image recognition learning information database 330 is shown in connection with the “building.”

Referring to FIG. 5, two items of image recognition learning information for the “building,” i.e., image recognition learning information for a skyscraper 331 often appearing in a “downtown region” and image recognition learning information for a thatched cottage 332 often appearing in a “rural region” are stored.

The image recognition learning information database 330 may be built by producing image recognition learning information having a different feature according to a geographical property through training for each image recognition object using training image information having the different feature according to the geographical property, and classifying the image recognition learning information according to the geographical property.

Referring back to FIG. 2, the image recognition learning information selector 400 extracts an image recognition object list including an image recognition object at a current position from the geographical property-specific image recognition object list database 320 based on the geographical property information of the current position, and outputs the extracted image recognition object list to the image recognition processor 500.

For example, when the geographical property information of the current position corresponds to a “rural region,” the image recognition learning information selector 400 extracts the image recognition object list 323 for the rural region from the geographical property-specific image recognition object list shown in FIG. 4 and outputs the image recognition object list 323 to the image recognition processor 500.

Meanwhile, the geographical property information of the current position may be input by, for example, the user via the input unit 410 or may be extracted from the geographical property information database 310, in which the geographical property information dependent on positions is stored, using the current position information received from the GPS receiver 200.

The input unit 410 is used to receive the current position information from the user or the manager. The current position information may be recognized using the GPS receiver 200 and the geographical property information database 310 described above, but when image recognition processing is performed in a space where the GPS system is unavailable or when the GPS receiver 200 and the geographical property information database 310 are not included to reduce a size of the image recognition apparatus, the current position information may be directly input via the input unit 410.

The memory 420 is used to store the geographical property information of the current position. For more efficient image recognition processing, the image recognition learning information selector 400 may compare previously stored geographical property information with the geographical property information of the current position, and use a previously extracted image recognition object list and image recognition learning information instead of extracting the image recognition object list and the image recognition learning information again when the geographical property information has not been changed. For this, the image recognition learning information selector 400 may store the geographical property information of the current position in the memory 420.

The image recognition processor 500 receives the image recognition object list from the image recognition learning information selector 400, extracts image recognition learning information corresponding to the image recognition object list from the image recognition learning information database 330, and compares the extracted image recognition learning information with the ambient-image information received from the ambient-image information acquisition unit 100 to determine whether there is image recognition learning information matching the ambient-image information. If there is image recognition learning information matching the ambient-image information, the image recognition processor 500 outputs the result of the determination to the controller 600, and otherwise, the image recognition processor 500 continues to perform the comparison.

For example, if the image recognition object list input from the image recognition learning information selector 400 is for the rural region including a “traffic sign,” a “traffic light,” a “car,” a “building,” a “pedestrian” and a “cultivator” as shown in FIG. 4, the image recognition processor 500 extracts corresponding image recognition learning information from the image recognition learning information database 330.

Meanwhile, the geographical property information of the current position may be included in the image recognition object list. In this case, the image recognition processor 500 may extract all image recognition learning information for the image recognition object, or may extract only image recognition learning information corresponding to the geographical property of the current position.

For example, when the geographical property of the current position corresponds to the “rural region,” the image recognition learning information selector 400 may not extract image recognition learning information for the skyscraper 331 that is a distinguishing building form of the “downtown region,” but may extract only image recognition learning information for the thatched cottage 332 that is a distinguishing building form of the “rural region.”

The controller 600 generates a control signal according to the image recognition determination result received from the image recognition processor 500, and outputs the generated control signal to the exterior.

The control signal may be an image signal used to output an image on the display or a sound signal used to output sound from a speaker.

The image output unit 610 outputs an image according to the image signal received from the controller 600, and the sound output unit 620 outputs sound according to a sound signal received from the controller 600.

For example, when a “thatched cottage” is recognized in the foreground of the vehicle or the robot, a statement “there is a thatched cottage ahead” or a corresponding image may be output on the display, or a guide remark “there is a thatched cottage ahead” may be output.

Hereinafter, an image recognition method using the apparatus for recognizing an image based on position information having the above-described configuration according to an exemplary embodiment of the present invention will be described.

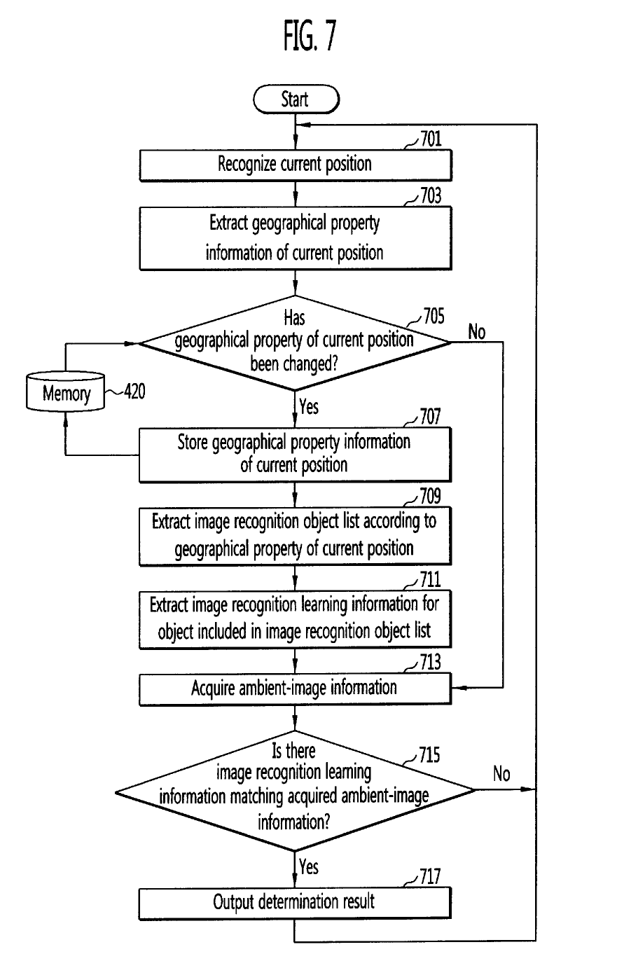

FIG. 6 is a flowchart illustrating a process of recognizing an image based on position information according to an exemplary embodiment of the present invention. Hereinafter, the process of recognizing an image based on position information according to an exemplary embodiment of the present invention will be described in greater detail with reference to FIG. 6.

In operation 601, the GPS receiver 200 outputs current position information recognized from a signal received from a satellite to the image recognition learning information selector 400.

In operation 603, the image recognition learning information selector 400 extracts geographical property information of the current position from the geographical property information database 310 based on the current position information received from the GPS receiver 200.

For example, when the geographical property information database 310 as shown in FIG. 3 is built and the current position information received from the GPS receiver 200 is “X20, Y15,” the image recognition learning information selector 400 extracts geographical property information of the current position, i.e., a “rural region,” based on the position information.

If a user or a manager inputs the geographical property information of the current position using the input unit 410, operations 601 and 603 may be omitted.

Meanwhile, in operation 609, the image recognition learning information selector 400 extracts an image recognition object list including an image recognition object at a current position from the geographical property-specific image recognition object list database 320 based on the extracted geographical property information of the current position, and outputs the extracted image recognition object list to the image recognition processor 500.

For example, when the geographical property-specific image recognition object list database 320 as shown in FIG. 4 is built and the extracted geographical property information of the current position corresponds to a “rural region,” the image recognition learning information selector 400 extracts the image recognition object list 323 for the rural region including a “traffic sign,” a “traffic light,” a “car,” a “building,” a “pedestrian” and a “cultivator,” based on the geographical property information of the current position, and outputs the image recognition object list 323 to the image recognition processor 500.

In operation 611, the image recognition processor 500 extracts image recognition learning information for an image recognition object included in the image recognition object list received from the image recognition learning information selector 400.

Meanwhile, the geographical property information of the current position may be included in the image recognition object list. When the image recognition learning information is extracted in operation 611, only image recognition learning information corresponding to the geographical property information of the current position may be extracted from image recognition learning information corresponding to the image recognition object list.

For example, it is assumed that the image recognition learning information database 330 as shown in FIG. 5 is built, the geographical property information of the current position corresponds to the “rural region,” and a “building” is included in an image recognition object list for the “rural region.” In extracting image recognition learning information for the building, only image recognition learning information for a thatched cottage 332 appearing mainly in the “rural region” may be extracted and image recognition learning information for a skyscraper 331 appearing mainly in the “urban region” may not be extracted.

In operation 613, the ambient-image information acquisition unit 100 outputs the ambient-image information produced by photographing an ambient image to the image recognition processor 500.

In operation 615, the image recognition processor 500 compares the ambient-image information acquired in operation 613 with the image recognition learning information extracted in operation 611 to determine whether there is image recognition learning information matching the ambient-image information.

If there is no image recognition learning information matching the ambient-image information, the image recognition processor 500 proceeds to operation 619, and otherwise, the image recognition processor 500 outputs the determination result to the controller and proceeds to operation 619.

In operation 619, the image recognition processor 500 determines whether a set time has lapsed. If the set time has not lapsed, the image recognition processor 500 proceeds to operation 613, and otherwise, the image recognition processor 500 proceeds to operation 601 to continue to perform the image recognition process. As the geographical property of the current position is confirmed only when the set time has lapsed, the amount of computation required for confirming the geographical property of the current position can be reduced. Operation 619 may be omitted according to the intention of the user or the manager.

Although not shown in FIG. 6, the controller 600 generates, in a subsequent operation, a control signal according to the determination result and outputs the control signal to the image output unit 610 and the sound output unit 620, which output an image and sound according to the received control signal, respectively.

The amount of computation required for image recognition processing can be reduced by extracting only the image recognition learning information for an object that may appear in a region having the geographical property of the current position and comparing the extracted image recognition learning information with the ambient-image information, as in the exemplary embodiment in FIG. 6 as described above.

Meanwhile, in order to additionally reduce the amount of computation required for confirming the geographical property of the current position, as well as the amount of computation required for extracting the image recognition learning information for an object included in the image recognition list, the image recognition object list may be extracted only when the geographical property of the current position is changed, and the image recognition learning information corresponding to the extracted image recognition object list may be extracted. This will be described with reference to FIG. 7.

FIG. 7 is a flowchart illustrating a process of recognizing an image based on position information according to another exemplary embodiment of the present invention.

Operations 701 and 703 are the same as operations 601 and 603 in FIG. 6.

In operation 705, the image recognition learning information selector 400 extracts previously stored geographical property information of a position from the memory 420 and compares the extracted geographical property information with the geographical property information of the current position to determine whether the geographical property information has been changed. If the geographical property information has been changed, the image recognition learning information selector 400 proceeds to operation 707, and otherwise, the image recognition learning information selector 400 proceeds to operation 713. In this case, if there is no geographical property information stored in the memory 420, the image recognition learning information selector 400 determines that the geographical property information has been changed and proceeds to operation 707.

In operation 707, the image recognition learning information selector 400 stores the geographical property information of the current position in the memory 420 and proceeds to operation 709.

Operations 709 to 717 are the same as operations 609 to 617 in FIG. 6.

As the image recognition object list is extracted only when the geographical property of the current position has been changed, and the image recognition learning information corresponding to the extracted image recognition object list is extracted, as in the exemplary embodiment in FIG. 7, an amount of computation for image recognition processing is reduced.

According to the present invention as described above, the amount of computation required for image recognition processing can be reduced by extracting only image recognition learning information for an object that may appear in a region having the geographical property of a current position and comparing the image recognition learning information with ambient-image information.

Also, the amount of computation required for image recognition processing can be reduced and the accuracy of image recognition processing can be increased by producing image recognition learning information having a different feature according to a geographical property for an object having a different feature according to a geographical property, extracting only image recognition learning information having a feature that may appear mainly in the geographical property of the current position from among image recognition learning information for an object that may appear in a region having the geographical property of the current position, and comparing the extracted image recognition learning information with the ambient-image information.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for recognizing an image based on position information, the apparatus comprising:
a global positioning system (GPS) receiver for receiving current position information;
an ambient-image information acquisition unit for acquiring ambient-image data by photographing an ambient image;
an image recognition learning information database for storing image recognition learning information for each image recognition object;
an image recognition learning information selector for selecting image recognition learning information associated with a geographical property of the current position from the image recognition learning information database based on the received current position information; and
an image recognition processor for performing image recognition on the acquired ambient-image data based on the selected image recognition learning information.

2. The apparatus of claim 1, further comprising a geographical property-specific image recognition object list database for storing an image recognition object list designating an image recognition object according to a geographical property, wherein:
the image recognition learning information selector extracts an image recognition object list including an image recognition object at the current position from the geographical property-specific image recognition object list database based on the received current position information, and
the image recognition processor searches for image recognition learning information corresponding to the extracted image recognition object list from the image recognition learning information database, and recognizes an image included in the ambient-image data based on the searched image recognition learning information.

3. The apparatus of claim 1, further comprising a geographical property information database for storing geographical property information dependent on positions, wherein:
the image recognition learning information selector extracts the geographical property information of the current position from the geographical property information database based on the received current position information.

4. The apparatus of claim 2, wherein the image recognition learning information database stores at least one item of image recognition learning information for each image recognition object produced using training image information having a different feature according to a geographical property.

5. The apparatus of claim 4, wherein the image recognition processor selects image recognition learning information having a feature corresponding to the geographical property of the current position from among the image recognition learning information corresponding to the extracted image recognition object list.

6. The apparatus of claim 1, further comprising a controller for generating a control signal according to the result of performing the image recognition.

7. The apparatus of claim 6, further comprising an output unit for outputting an image or sound according to the control signal.

8. A method of recognizing an image based on position information, the method comprising:
receiving current position information;
acquiring ambient-image data by photographing an ambient image;
selecting image recognition learning information associated with a geographical property of the current position based on the received current position information; and
performing image recognition on the acquired ambient-image data based on the selected image recognition learning information.

9. The method of claim 8, wherein the selecting of the image recognition learning information comprises:
extracting an image recognition object list including an image recognition object at the current position based on the received current position information; and
searching for and selecting image recognition learning information corresponding to the extracted image recognition object list.

10. The method of claim 8, wherein receiving the current position information comprises receiving the current position information from a user or using a GPS.

11. The method of claim 9, further comprising building an image recognition learning information database for storing image recognition learning information for each image recognition object.

12. The method of claim 11, wherein building the image recognition learning information database comprises producing at least one item of image recognition learning information for each image recognition object using training image information having a different feature according to a geographical property.

13. The method of claim 12, wherein searching and selecting the image recognition learning information comprises extracting image recognition learning information having a feature corresponding to the geographical property of the current position from among the image recognition learning information corresponding to the extracted image recognition object list.

14. The method of claim 8, further comprising building a geographical property information database for storing geographical property information dependent on positions.

15. The method of claim 9, further comprising building a geographical property-specific image recognition object list database for storing an image recognition object list designating an image recognition object according to a geographical property.

16. The method of claim 8, further comprising generating a control signal according to the result of performing the image recognition.

17. The method of claim 16, further comprising outputting an image or sound according to the control signal.
